(19) United States
(12) Patent Application Publication
(10) Pub. No.: US 2026/0223080 A1
(43) Pub. Date: Jul. 30, 2026

(54) SIGNALLING METHODS TO SUPPORT MULTIPLE WAVEFORMS IN A WIRELESS COMMUNICATION SYSTEM

(71) Applicants: CENTRE OF EXCELLENCE IN WIRELESS TECHNOLOGY, Chennai, Tamil Nadu (IN); INDIAN INSTITUTE OF TECHNOLOGY MADRAS (IIT Madras), Tamil Nadu (IN)

(72) Inventors: Thirunageswaram Ramachandran RAMYA, Chennai (IN); Ebin CHACKO, Chennai (IN); Dileep BAPATLA, Chennai (IN); Jeniston Deviraj KLUTTO MILLETH, Chennai (IN); Bhaskar RAMAMURTHI, Chennai (IN)

(21) Appl. No.: 19/141,655

(22) PCT Filed: Dec. 20, 2023
(86) PCT No.: PCT/IN2023/051200

§ 371 Date: Jun. 20, 2025

(30) Foreign Application Priority Data
Dec. 20, 2022 (IN) 202241073911

(51) Int. Cl. H04W 72/044; H04W 72/51; H04W 72/542

(52) U.S. Cl. CPC H04W 72/044; H04W 72/51; H04W 72/542

(57) ABSTRACT

A method for performing signaling in a wireless communication system is described. The method comprises receiving, by a first node, at least one of capability information and Channel State Information (CSI) from a second node. The first node receives at least one traffic specific information. The first node selects at least one waveform from a plurality of waveforms based on the at least one of the capability information, the CSI, and the at least one traffic specific information. The first node signals the at least one waveform to the second node. The first node performs at least one of transmitting and receiving using the at least one waveform.

### FIELD OF THE INVENTION

The present invention relates to a wireless communication system, and more particularly to signalling methods to support multiple waveforms in the wireless communication system.

### BACKGROUND OF THE INVENTION

Cellular communication technologies are evolving to improve the data rate, reduce latency, support higher mobility and higher device connectivity. Future standards are expected to support new additional waveforms to handle various deployment scenarios and other service requirements. Hence, waveform selection is one of the important aspects of cellular broadband wireless communication technology. The choice of the waveform depends on various criteria such as, good time and frequency localization, low Peak to Average Power Ratio (PAPR), support for Multiple Input Multiple Output (MIMO) systems, lower complexity etc. Orthogonal Frequency Division Multiplexing (OFDM) is selected as a waveform for Fourth Generation (4G) and Fifth Generation (5G) systems owing to the various benefits offered and ease of implementation. 4G and 5G systems support Cyclic Prefix-Orthogonal frequency division multiplexing (CP-OFDM) waveform, and Discrete Fourier Transform-Spread-Orthogonal frequency division multiplexing (DFT-s-OFDM) waveform. The DFT-s-OFDM is chosen for Uplink (UL) transmissions to enhance coverage for cell edge User Equipment (UE).

Closed loop adaptive systems help to cope with the time varying wireless channel. However, there is a need for measurement of the channel characteristics at the receiver in the closed loop systems and the various channel parameters based on the measurement is to be reported to the transmitter. The present New Radio (NR) system uses a codebook-based Channel State Information (CSI) reporting mechanism, which is more suitable for low and medium speed UEs. The mechanism requires frequent CSI reporting to improve the performance at higher speeds, thereby increasing the feedback overhead significantly. This motivates the need for a waveform that is more resilient to high Doppler frequencies without significant increase in the CSI feedback overhead.

Orthogonal Time Frequency Space (OTFS) is a waveform that is well studied in literature and has been proven to handle very high Doppler frequencies due to high speeds. In case of OTFS, the channel is envisioned in the delay-Doppler domain as opposed to the time-frequency domain in OFDM based waveforms. The number of channel taps in delay domain are much less compared to that in the frequency domain and the variations in Doppler domain are much less compared to the variations in time domain. Therefore, the channel appears sparse and is slowly varying in the delay-Doppler domain. Hence, the requirements on CSI reporting is reduced due to less frequent CSI reporting comprising of a few channel values. Therefore, the Reference Signals (RS) is transmitted at lower frequency. The low frequency RS transmission and less frequent CSI reporting together contribute to the improvement of the throughput and reliability of the system.

The implementation of the OTFS is accomplished as on overlay on the OFDM system chain, by adding a few additional blocks to the OFDM transmit-receive structure. This is advantageous for new systems that employ the OTFS over the existing OFDM systems leading to faster layout.

The OTFS offers advantages for high speed UEs. However, the decoder for OTFS signal is quite complex. The modulated symbols are mapped on to a delay-Doppler grid which is transformed into time-frequency grid to enable transmission on the channel. At the receiver, conversion to delay-Doppler domain is possible only after the reception of the entire time-frequency grid allocated for a specific user. This leads to higher latency. Therefore, the OTFS is more suitable for the UEs that can support higher complexity and applications that are not latency constrained. However, 5G and beyond systems support diverse use cases with data rates ranging from few bytes to giga bytes, latency requirement ranging from low to ultra-low latency, mobility requirement ranging from stationary devices to ultra-highspeed devices. Similarly, the UE capabilities are also diverse, ranging from simple sensors to hotspots.

In order to accommodate various use case scenarios, different UE capabilities and UEs at different distance from Base Station (BS), there is a need for the BS to support multiple waveforms such as OTFS, CP-OFDM and DFT-s-OFDM and choose one based on the requirement. This is feasible since the OTFS waveform can be implemented using certain additional blocks on the existing OFDM waveform generation chain. Table 1 highlights the advantages and disadvantages of each of the waveforms.

TABLE 1
Advantages and disadvantages of
CP-OFDM, DFT-S-OFDM and OTFS

| | Low | | Implemen- | | |
|---|---|---|---|---|---|
| | Latency | Mobility | tation | | |
| Waveform | Support | Supported | Complexity | PAPR | Coverage |
| CP- | Yes | Low to high | Moderate | High | Moderate |
| OFDM | | | | | |
| DFT-S- | Yes | Low to high | Moderate | Low | High |
| OFDM | | | | | |
| OTFS | No | Low to very | High | Moderate | Moderate |
| | | high | | | |

Thus, there is a need for the present invention to select a suitable waveform based on the traffic, data rate requirements, complexity supported at the UE, latency constraints, distance from the BS, and mobility of the UE. The selected waveform should also ensure reduced CSI feedback overhead and increase in the throughput and reliability of the wireless communication system.

### OBJECTS OF THE INVENTION

A general objective of the present invention is to provide signalling methods to support multiple waveforms in the wireless communication system.

Another objective of the invention is to provide signalling methods to reduce Channel State Information (CSI) feedback overhead and to increase throughput and reliability of the wireless communication system.

### SUMMARY OF THE INVENTION

The summary is provided to introduce aspects related to channel bandwidth adaptation in a cellular network, and the aspects are further described below in the detailed description. This summary is not intended to identify essential features of the claimed subject matter nor is it intended for use in determining or limiting the scope of the claimed subject matter.

In one embodiment, a method for performing signaling in a wireless communication system using multiple waveforms is described. The method comprises receiving, by at least one first node, at least one of capability information and Channel State Information (CSI) from at least one second node, the method further comprises receiving, by the at least one first node (102), at least one traffic specific information, the method further comprises selecting, by the at least one first node, at least one waveform from a plurality of waveforms based on the at least one of the capability information, the CSI, and the at least one traffic specific information, the method further comprises signaling, by the at least one first node, the at least one waveform to the at least one second node and performing, by the at least one first node, at least one of transmitting and receiving using the at least one waveform.

In one aspect, the capability information of the at least one second node comprises at least one of capability to support the at least one waveform of the plurality of waveforms, capability to support low latency, capability to support higher data rate transmission/reception, capability to support mobility, capability to support higher coverage, and capability to support higher implementation complexity.

In one aspect, the method further comprises determining, by the at least one first node, speed of the at least one second node and distance between the at least one first node and the at least one second node, based on the CSI received from the at least one second node.

In one aspect, the at least one traffic specific detail comprises at least one of data rate and latency constraints.

In one aspect, the at least one first node selects the at least one waveform from the plurality of waveforms comprising at least one of Orthogonal time frequency space (OTFS) waveform, Cyclic Prefix-Orthogonal frequency division multiplexing (CP-OFDM) waveform, and Discrete Fourier Transform-Spread-Orthogonal frequency division multiplexing (DFT-s-OFDM) waveform.

In one aspect, the at least one traffic is classified as one of low, medium, and high based on at least one metric, wherein the at least one metric includes data rate, latency, mobility, and coverage.

In one aspect, the capability information comprises a bitmap of length equal to number of capabilities of the at least one second node.

In one aspect, the at least one first node receives the capability information from the at least one second node as an index mapped to the capability information.

In one aspect, the at least one first node selects the at least one waveform before scheduling a Downlink (DL) transmission or providing a grant for an Uplink (UL) transmission.

In one aspect, the at least one first node transmits capability signaling to the at least one second node, wherein the capability signaling comprises capability to support a single waveform or the plurality of waveforms.

In one aspect, the at least one first node transmits the capability signaling to the at least one second node in at least one of Physical Broadcast Channel (PBCH) and System Information Block (SIB).

In one aspect, the at least one first node is selected by the at least one second node based on the capability signaling.

In one aspect, the at least one first node receives the capability information from the at least one second node using at least one of Radio Resource Control (RRC), Medium Access Control-Control Element (MAC-CE) and L1 Control signaling.

In one aspect, the at least one first node uses at least one of the RRC, the MAC-CE and the L1 Control signaling to indicate the at least one waveform.

In one aspect, the at least one first node indicates resources for the at least one second node in time-frequency grid using at least one Information Element (IE) in the RRC and Downlink Control Information (DCI).

In one aspect, the at least one IE comprises time resources in terms of combinations of symbols and slots and frequency region in terms of Resource Blocks (RBs) and Identity (ID) of a Bandwidth Part (BWP) associated with frequency resources.

In one aspect, at least two second nodes share between themselves same time-frequency resources and different regions allocated within a delay-Doppler grid.

In one aspect, the at least one first node indicates a total time-frequency grid to the at least one second node using the at least one IE in the RRC.

In one aspect, the at least one first node indicates a specific region within the delay-Doppler grid to the at least one second node in the L1 control signaling.

In one aspect, the at least one first node signals configuration information for at least one Reference signal (RS) to the at least one second node.

In one aspect, the at least one first node configures a default location for the at least one RS.

In one aspect, the default location for placing the at least one RS comprise at least one of center of the delay-Doppler grid, upper left corner of the delay-Doppler grid, lower left corner of the delay-Doppler grid, upper right corner of the delay-Doppler grid, and lower right corner of the delay-Doppler grid.

In one aspect, the default location includes a guard region, wherein a size of the guard region is based on maximum delay spread of a channel in delay axis and maximum Doppler spread of a channel in Doppler axis.

In one aspect, a total number of RS is decided based on at least one of signal-to-interference-plus-noise ratio (SINR), Modulation Coding Scheme (MCS) and Chanel Quality Indicator (CQI).

In one aspect, a gap between at least two RS is greater than the delay spread in delay axis and greater than the Doppler spread in the Doppler axis.

In one aspect, a common RS region is defined for at least two second nodes using the same time-frequency grid and different regions within the delay-Doppler grid.

In one aspect, the at least one RS is retrieved from the common RS region and used to estimate the channel.

In one aspect, the at least one first node uses a default waveform to communicate with the at least one second node, wherein the default waveform is at least one of the OTFS, the CP-OFDM, and the DFT-s-OFDM.

In one embodiment, a method for performing signaling using multiple waveforms in a wireless communication system is described. The method comprises transmitting, by at least one second node, at least one of capability information and Channel State Information (CSI) to at least one first node, the method further comprises receiving, by at least one second node, at least one waveform from a plurality of waveforms from the at least one first node, wherein the at least one waveform is selected by the at least one first node based on at least one of the capability information, the CSI, and at least one traffic specific information.

In one aspect, the at least one second node switches to the at least one waveform signaled by the at least one first node.

In one aspect, the capability information of the at least one second node comprises at least one of capability to support the at least one waveform of the plurality of waveforms, capability to support low latency, capability to support higher data rate transmission/reception, capability to support mobility, capability to support higher coverage, and capability to support higher implementation complexity.

In one aspect, the at least one traffic specific information comprises at least one of data rate and latency constraints.

In one aspect, the at least one first node selects the at least one waveform from the plurality of waveforms comprising at least one of Orthogonal time frequency space (OTFS) waveform, Cyclic Prefix-Orthogonal frequency division multiplexing (CP-OFDM) waveform, and Discrete Fourier Transform-Spread-Orthogonal frequency division multiplexing (DFT-s-OFDM) waveform.

In one aspect, the at least one waveform is classified as one of low, medium and high based on at least one metric, wherein the at least one metric includes data rate, latency, mobility, and coverage.

In one aspect, the capability information comprises a bitmap of length equal to number of capabilities of the at least one second node.

In one aspect, the at least one second node transmits the capability information to the at least one first node as an index mapped to the capability information.

In one aspect, the at least one first node selects the at least one waveform before scheduling a Downlink (DL) transmission or providing a grant for an Uplink (UL) transmission.

In one aspect, the at least one second node receives capability signaling from the at least one first node, wherein the capability signaling comprises capability to support a single waveform or the plurality of waveforms.

In one aspect, the at least one second node receives the capability signaling from the at least one first node in at least one of Physical Broadcast Channel (PBCH) and System Information Block (SIB).

In one aspect, the at least one second node selects the at least one first node based on the capability signaling.

In one aspect, the at least one second node transmits the capability information to the at least one first node using at least one of Radio Resource Control (RRC), Medium Access Control-Control Element (MAC-CE) and L1 Control signaling.

In one aspect, the at least one first node uses at least one of the RRC, the MAC-CE and the L1 Control signaling to indicate the at least one waveform.

In one aspect, the at least one first node indicates resources for the at least one second node in time-frequency grid using at least one Information Element (IE) in the RRC and L1 control signaling.

In one aspect, the at least one IE comprises time resources in terms of combinations of symbols and slots and frequency region in terms of Resource Blocks (RBs) and Identity (ID) of a Bandwidth Part (BWP) associated with frequency resources.

In one aspect, at least two second nodes share same time-frequency resources and different regions allocated within a delay-Doppler grid.

In one aspect, the at least one first node indicates a total time-frequency grid to the at least one second node using the at least one IE in the RRC.

In one aspect, the at least one first node indicates a specific region within the delay-Doppler grid in the L1 control signaling.

In one aspect, the at least one second node receives configuration information for at least one Reference signal (RS) from the at least one first node.

In one aspect, the at least one first node configures a default location for the at least one RS.

In one aspect, the default location for placing the at least one RS comprise at least one of center of the delay-Doppler grid, upper left corner of the delay-Doppler grid, lower left corner of the delay-Doppler grid, upper right corner of the delay-Doppler grid, and lower right corner of the delay-Doppler grid.

In one aspect, the default location includes a guard region, wherein a size of the guard region is based on maximum delay spread of a channel in delay axis and maximum Doppler spread of a channel in Doppler axis.

In one aspect, a total number of RS is decided based on at least one of signal-to-interference-plus-noise ratio (SINR), Modulation Coding Scheme (MCS) and Chanel Quality Indicator (CQI).

In one aspect, a gap between at least two RS is greater than the delay spread in delay axis and greater than the Doppler spread in the Doppler axis.

In one aspect, a common RS region is defined for at least second node s using the same time-frequency grid and different regions within the delay-Doppler grid.

In one aspect, the at least one RS is retrieved from the common RS region and used to estimate the channel.

In one aspect, the at least one second node uses a default waveform to communicate with the at least one first node, wherein the default waveform is at least one of the OTFS, the CP-OFDM, and the DFT-s-OFDM.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an architecture of a cellular network for providing communication between a Base Station and User Equipments (UE), in accordance with an embodiment of the present invention.

FIG. 2 illustrates a flow chart of a method for performing signaling in a wireless communication system using multiple waveforms, in accordance with an embodiment of the present invention.

FIG. 3 illustrates a flow chart of a method for performing signaling in a wireless communication system using multiple waveforms, in accordance with an embodiment of the present invention.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

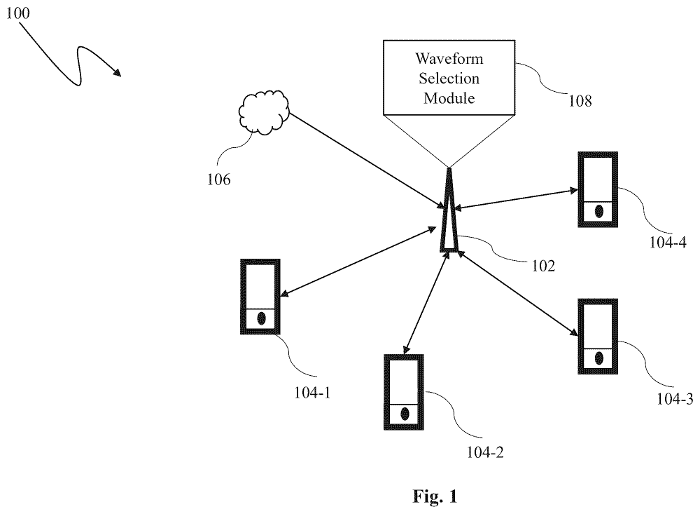

FIG. 1 illustrates an architecture of a cellular network 100 for providing communication between a Base Station (BS) 102 and User Equipments (UEs) 104-1, 104-2, 104-3, and 104-4 in accordance with an embodiment of the present invention. The UEs 104-1, 104-2, 104-3, and 104-4 are cumulatively referred as a UE 104 for the case of labelling and explanation. The BS 102 may include a Waveform Selection Module 108. The BS 102 may communicate with the UE 104 and higher layers 106 of the network 100.

The present invention relates to signalling methods to support multiple waveforms in the wireless communication system 100. Also, the present invention relates to signalling methods to reduce Channel State Information (CSI) feedback overhead and to increase throughput and reliability of the wireless communication system 100.

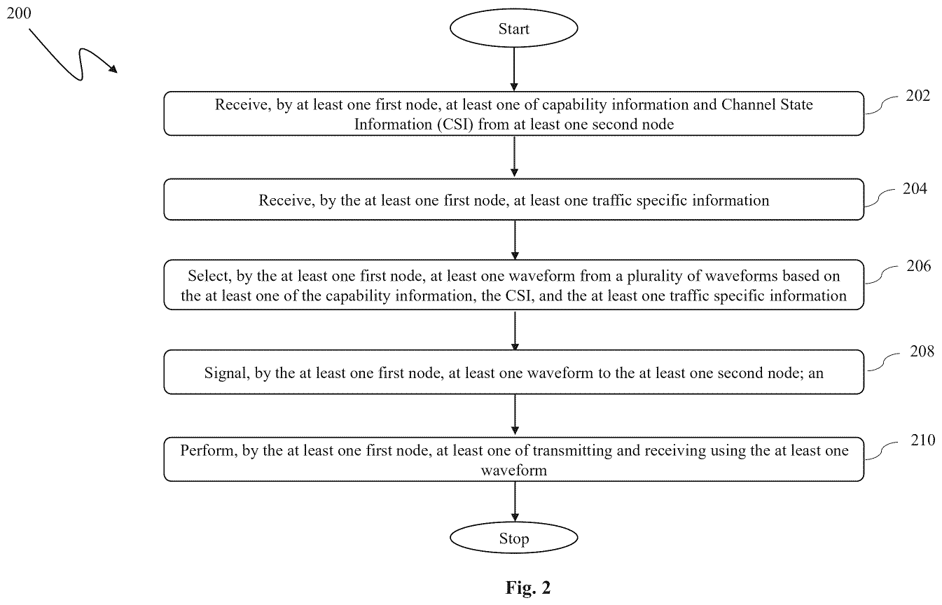

FIG. 2 illustrates a flow chart of a method for performing signaling in a wireless communication system using multiple waveforms, in accordance with an embodiment of the present invention. It should also be noted that in some alternative implementations, the functions noted in the blocks may occur out of the order noted in the drawings. For example, two blocks shown in succession in FIG. 2 may in fact be executed substantially concurrently or the blocks may sometimes be executed in the reverse order, depending upon the functionality involved. Alternate implementations are included within the scope of the example embodiments in which functions may be executed out of order from that shown or discussed, including substantially concurrently or in reverse order, depending on the functionality involved.

The BS 102 may receive at least one of capability information and Channel State Information (CSI) from the UE 104, at step 202. The BS 102 may receive at least one traffic specific information from the higher layers 106, at step 204. The BS 102 may select at least one waveform from a plurality of waveforms based on the at least one of the capability information, the CSI, and the at least one traffic specific information, at step 206. The BS 102 may signal the at least one waveform to the UE 104, at step 208. The BS 102 may perform at least one of transmitting and receiving using the at least one waveform, at step 210.

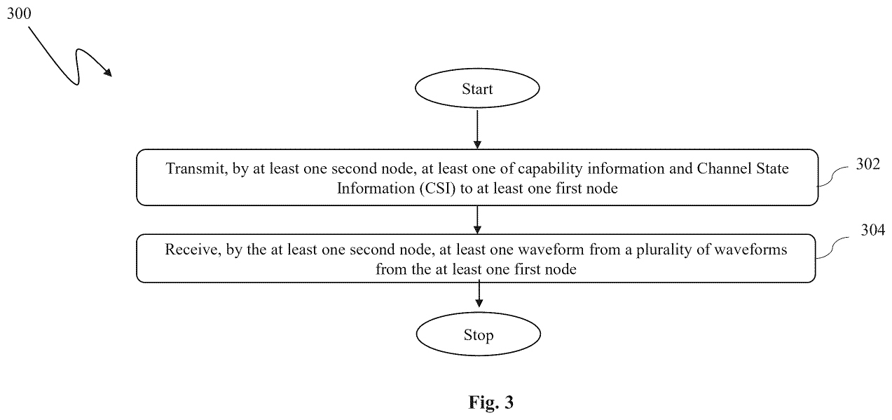

FIG. 3 illustrates a flow chart of a method for performing signaling in a wireless communication system using multiple waveforms, in accordance with an embodiment of the present invention. It should also be noted that in some alternative implementations, the functions noted in the blocks may occur out of the order noted in the drawings. For example, two blocks shown in succession in FIG. 3 may in fact be executed substantially concurrently or the blocks may sometimes be executed in the reverse order, depending upon the functionality involved. Alternate implementations are included within the scope of the example embodiments in which functions may be executed out of order from that shown or discussed, including substantially concurrently or in reverse order, depending on the functionality involved.

The UE 104 may transmit at least one of capability information and Channel State Information (CSI) to the BS 102, at step 302. The UE 104 may receive at least one waveform from a plurality of waveforms from the BS 102, at step 304. The at least one waveform may be selected by the waveform selection module 108 of the BS 102 based on at least one of the capability information and the CSI from the UE 104 and at least one traffic specific information from the higher layers 106.

The capability information of the UE 104 may comprise at least one of capability to support the at least one waveform of the plurality of waveforms, capability to support low latency, capability to support higher data rate transmission/reception, capability to support mobility, capability to support higher coverage, and capability to support higher implementation complexity. The at least one traffic specific detail may comprise at least one of data rate and latency constraints. The BS 102 may determine speed of the UE 104 and distance between them based on the CSI received from the UE 104.

The waveform selection module 108 of the BS 102 may select the at least one waveform from the plurality of waveforms comprising at least one of Orthogonal time frequency space (OTFS) waveform, Cyclic Prefix-Orthogonal frequency division multiplexing (CP-OFDM) waveform, and Discrete Fourier Transform-Spread-Orthogonal frequency division multiplexing (DFT-s-OFDM) waveform.

The waveform selection module 108 of the BS 102 may select the at least one waveform based on the traffic, data rate requirements, complexity supported at the UE 104, latency constraints, distance between the UE 104 and the BS 102, and mobility of the UE 104. The UE 104 may signal the capability information to the BS 102. When reporting the capability, the UE 104 may report all the possible combinations with different waveforms and different capabilities. Table 2 illustrates some of the possible capabilities that may be reported by the UE 104 to the BS 102.

TABLE 2
Waveforms and capabilities

| | Data Rate | Low Latency | Mobility | Coverage |
|---|---|---|---|---|
| Waveform | Supported | Support | Supported | Supported |
| CP-OFDM-low | Low | Low Latency | Low | Moderate |
| CP-OFDM-medium | Medium | Low Latency | Moderate | Moderate |
| CP-OFDM-high | High | Ultra-low | Moderate | Moderate |
| | | Latency | to High | |
| DFT-S-OFDM-low | Low | Low Latency | Low | High |
| DFT-S-OFDM- | Moderate | Low Latency | Moderate | High |
| medium | | | | |
| DFT-S-OFDM-high | High | Ultra-low | Moderate | High |
| | | Latency | to High | |
| OTFS | High | Moderate | Ultra-high | Moderate |
| | | Latency | | |

As illustrated in Table 2, the waveforms CP-OFDM and DFT-s-OFDM may be classified into low, medium and high based on the different capabilities. For example, the waveform CP-OFDM-high may support high data rates, ultra-low latency applications and support high mobility. This may be achieved by various factors that may result in very high implementation complexity. Hence, the waveform CP-OFDM-high may be suitable for applications that require huge data rates and for high end UEs that may support the required complexity. The waveform CP-OFDM-low may support low data rates with limited mobility and therefore may result in low implementation complexity. The waveform CP-OFDM-low may be suitable for simple applications for which low data rates and moderate latency may be sufficient and for low end UEs with limited capabilities.

In one aspect, the BS 102 may receive the capability information from the UE 104 as a bitmap of length equal to number of capabilities of the UE 104. A corresponding bit of the bitmap may be set to zero or one based on the capability of the UE 104.

In one aspect, the BS 102 may receive the capability information from the UE 104 as an index of a table mapped to the capability information. The table may be defined comprising a set of all possible combinations of the capabilities of the UE 104. The UE 104 may transmit the index of the table that corresponds to a suitable combination of capabilities to the BS 102.

The waveform selection module 108 of the BS 102 may select the at least one waveform before scheduling a Downlink (DL) transmission or providing a grant for an Uplink (UL) transmission.

The BS 102 may transmit capability signaling to the UE 104 in at least one of Physical Broadcast Channel (PBCH) and System Information Block (SIB). The capability signaling may comprise capability of the BS 102 to support a single waveform or the plurality of waveforms. The plurality of waveforms may comprise at least one of CPOFDM, DFT-s-OFDM and OTFS. The UE 104 may choose the BS 102 based on the capability signaling. The capability signaling may use reserved bits in PBCH to enable the UE 104 to decide at the earliest.

The BS 102 may receive the capability information from the UE 104 using at least one of Radio Resource Control (RRC), Medium Access Control-Control Element (MAC-CE) and L1 Control signaling. The BS 102 may be signalled about the waveforms supported by the UE 104 to enable the BS 102 to switch to a different waveform based on the capability information and based on traffic requirements.

The BS 102 may signal the UE 104 to switch to at least one waveform from the plurality of waveforms comprising OTFS, CP-OFDM and DFT-s-OFDM, as and when required. The BS 102 may use at least one of the RRC, the MAC-CE and the L1 Control signaling to indicate the at least one waveform to the UE 104.

In one aspect, the BS 102 may signal the UE 104 through the RRC, using the at least one Information Element (IE) in RRC. The at least one IE may comprise at least one of a Physical Downlink Shared Channel (PDSCH) configuration IE for the DL, a Physical Uplink Shared Channel (PUSCH) configuration IE for the UL and a new IE.

In one aspect, the BS 102 may use a two-bit field in a Downlink Control Information (DCI) along with a PDSCH scheduling or a PUSCH scheduling to indicate the plurality of the waveforms to the UE 104.

In one aspect, the BS 102 may indicate resources for the UE 104 in time-frequency grid using the at least one IE in the RRC and DCI. The at least one IE may comprise time resources in terms of combinations of symbols and slots and frequency region in terms of Resource Blocks (RBs) and Identity (ID) of a Bandwidth Part (BWP) associated with frequency resources. At least two UE 104 may share same time-frequency resources and different regions allocated within a delay-Doppler grid between themselves.

In one aspect, the BS 102 may indicate resources for the UE 104 in time-frequency grid using the at least one IE in the RRC and DCI. The BS 102 may indicate a total time-frequency grid to the UE 104 using the at least one IE in the RRC. The BS 102 may indicate a specific region within the delay-Doppler grid in the DCI using Time-Domain Resource Allocation (TDRA) or Frequency Domain Resource Allocation (FDRA) fields.

The channel experienced in every location within the delay-Doppler grid may be the same and hence, Reference Signal (RS) may be placed in a default location. The BS 102 may place the RS in the default location. The default location includes a guard region, at least equal to delay spread in delay axis and Doppler spread in Doppler axis. The default location for placing the RS may comprise at least one of center of the delay-Doppler grid, upper left corner of the delay-Doppler grid, lower left corner of the delay-Doppler grid, upper right corner of the delay-Doppler grid, and lower right corner of the delay-Doppler grid. For example, in a (M, N) grid, the RS may be placed at location (M/2, N/2) or (floor (M/2), floor (N/2)).

The BS 102 may place multiple RS to improve the estimation accuracy. The total number of RS may be decided based on Signal-to-Interference-Plus-Noise Ratio (SINR), Modulation Coding Scheme (MCS) and Chanel Quality Indicator (CQI). The number of RS may be increased when the SINR/CQI/MCS decreases and the number of RS may be decreased when the SINR/CQI/MCS increases. The gap between two RS may be greater than the delay spread in delay axis and greater than the Doppler spread in the Doppler axis.

In one aspect, a common RS region may be defined for the at least two UE 104 sharing same time-frequency grid and different regions allocated within a delay-Doppler grid. The channel may remain the same within the delay-Doppler grid, irrespective of the location. The UE 104 may retrieve the RS from the common RS region and may estimate the channel, thereby reducing the RS overhead.

The BS 102 may use a default waveform to communicate with the UE 104. The default waveform may be at least one of the OTFS, the CP-OFDM, and the DFT-s-OFDM. When the UE 104 does not receive any indication from the BS 102 about the selected waveform, the UE 104 may use the default waveform to communicate with the BS 102.

Thus, the BS 102 in the present invention utilizes the capacity information of the UE 104 and selects the suitable waveform in the wireless communication system 100. The present invention also reduces Channel State Information (CSI) feedback overhead and increases throughput and reliability of the wireless communication system

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

1. A method for performing signaling in a wireless communication system using multiple waveforms, the method comprising:
receiving, by at least one first node, at least one of capability information and Channel State Information (CSI) from at least one second node;
receiving, by the at least one first node, at least one traffic specific information;
selecting, by the at least one first node, at least one waveform from a plurality of waveforms based on the at least one of the capability information, the CSI, and the at least one traffic specific information;
signaling, by the at least one first node, the at least one waveform to the at least one second node; and
performing, by the at least one first node, at least one of transmitting and receiving using the at least one waveform.

2. The method as claimed in claim 1, wherein the capability information of the at least one second node comprises at least one of capability to support the at least one waveform of the plurality of waveforms, capability to support low latency, capability to support higher data rate transmission/reception, capability to support mobility, capability to support higher coverage, and capability to support higher implementation complexity.

3. The method as claimed in claim 1, further comprising:
determining, by the at least one first node, speed of the at least one second node and distance between the at least one first node and the at least one second node, based on the CSI received from the at least one second node.

4. (canceled)

5. The method as claimed in claim 1, wherein the at least one first node selects the at least one waveform from the plurality of waveforms comprising at least one of Orthogonal time frequency space (OTFS) waveform, Cyclic Prefix-Orthogonal frequency division multiplexing (CP-OFDM) waveform, and Discrete Fourier Transform-Spread-Orthogonal frequency division multiplexing (DFT-s-OFDM) waveform.

6. The method as claimed in claim 1, wherein the at least one traffic specific information is classified as one of low, medium, and high based on at least one metric, wherein the at least one metric includes data rate, latency, mobility, and coverage.

7. (canceled)

8. (canceled)

9. (canceled)

10. (canceled)

11. (canceled)

12. The method as claimed in claim 1, wherein the at least one first node is selected by the at least one second node based on the capability signaling.

13. The method as claimed in claim 1, wherein the at least one first node receives the capability information from the at least one second node using at least one of Radio Resource Control (RRC), Medium Access Control-Control Element (MAC-CE) and L1 Control signaling.

14. The method as claimed in claim 13, wherein the at least one first node uses at least one of the RRC, the MAC-CE and the L1 Control signaling to indicate the at least one waveform.

15. The method as claimed in claim 13, wherein the at least one first node indicates resources for the at least one second node in a time-frequency grid using at least one Information Element (IE) in the RRC and a Downlink Control Information (DCI).

16. The method as claimed in claim 15, wherein the at least one IE comprises time resources in terms of combinations of symbols and slots and frequency region in terms of Resource Blocks (RBs) and Identity (ID) of a Bandwidth Part (BWP) associated with frequency resources.

17. The method as claimed in claim 15, wherein at least two second nodes share between themselves same time-frequency resources and different regions allocated within a delay-Doppler grid.

18. The method as claimed in claim 17, wherein the at least one first node indicates a total time-frequency grid to the at least one second node using the at least one IE in the RRC.

19. The method as claimed in claim 17, wherein the at least one first node indicates a specific region within the delay-Doppler grid to the at least one second node in the L1 control signaling.

20. The method as claimed in claim 1, wherein the at least one first node signals configuration information for at least one Reference signal (RS) to the at least one second node.

21. (canceled)

22. The method as claimed in claim 20, wherein a default location for placing the at least one RS comprise at least one of a center of a delay-Doppler grid, an upper left corner of the delay-Doppler grid, a lower left corner of the delay-Doppler grid, an upper right corner of the delay-Doppler grid, and a lower right corner of the delay-Doppler grid.

23. The method as claimed in claim 22, wherein the default location includes a guard region, wherein a size of the guard region is based on maximum delay spread of a channel in delay axis and maximum Doppler spread of a channel in Doppler axis.

24. The method as claimed in claim 20, wherein a total number of the at least one RS is decided based on at least one of signal-to-interference-plus-noise ratio (SINR), Modulation Coding Scheme (MCS) and Chanel Quality Indicator (CQI).

25. (canceled)

26. The method as claimed in claim 20, wherein a common RS region is defined for at least two second nodes using a same time-frequency grid and different regions within a delay-Doppler grid.

27. (canceled)

28. The method as claimed in claim 1, wherein the at least one first node uses a default waveform to communicate with the at least one second node, wherein the default waveform is at least one of OTFS, CP-OFDM, and DFT-s-OFDM.

29. A method for performing signaling using multiple waveforms in a wireless communication system, the method comprising:
transmitting, by at least one second node, at least one of capability information and Channel State Information (CSI) to at least one first node; and
receiving, by the at least one second node, at least one waveform from a plurality of waveforms from the at least one first node, wherein the at least one waveform is selected by the at least one first node based on at least one of the capability information, the CSI, and at least one traffic specific information.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)
